(19) United States
(12) Patent Application Publication
(10) Pub. No.: US 2022/0374915 A1
(43) Pub. Date: Nov. 24, 2022

(54) APPARATUS FOR CHECKING LEGISLATION ON CHEMICALS, AND METHOD THEREFOR

(71) Applicant: SAFETY ASSESSMENT SOLUTION CO., LTD., Seoul (KR)

(72) Inventors: Hee June SHIN, Gimpo-si (KR); Yoon Kyoo CHOI, Seoul (KR)

(21) Appl. No.: 17/761,159

(22) PCT Filed: Sep. 17, 2020
(86) PCT No.: PCT/KR2020/012544

§ 371 Date: Mar. 16, 2022

(30) Foreign Application Priority Data
Sep. 17, 2019 (KR) 10-2019-0114188

(51) Int. Cl. G06Q 30/00; G06Q 50/18

(52) U.S. Cl. CPC G06Q 30/018; G06Q 50/18

(57) ABSTRACT

The present invention relates to an apparatus for checking legislation on chemicals, and a method therefor, and the objective of the present invention is to: discriminate analysis information so that nation-specific legislation on chemicals can be responded to; and, according to the result of discrimination, automatically provide, for each use, the required obligations according to legislation, on a corresponding chemical, of a corresponding nation. In one embodiment, disclosed is an apparatus for checking legislation, comprising: an analysis unit, which performs a qualitative and quantitative analysis function for a chemical or a chemical product, so as to identify the structure and concentration of the chemical or a chemical contained in the chemical product, thereby confirming the name and quantity of the chemical or the chemical product; a control unit, which checks, on the basis of the name, purpose of use and amount of the chemical or the chemical product and the legislation information of a nation to which the chemical or the chemical product is to be applied, whether the chemical or the chemical product is eligible for registration and evaluation, and falls under, in the respective order, cosmetics legislation, pharmaceutical affairs legislation, an narcotics control legislation, so as to retrieve the requirements of the legislation on the corresponding matters; and a display unit for outputting the requirements of the legislation having been retrieved through the control unit.

### TECHNICAL FIELD

The present invention relates to a device and method for reviewing legislation on chemical substances and, in particular, to a device and method for determining analysis information to allow chemical substances and chemical products to meet each country's legislation and automatically provide obligations according to the corresponding country's legislation, according to uses.

Further, the present invention relates to a device and method that determines analysis information to meet each country's legislation on high molecular weight compounds among chemical substances and automatically provides obligations according to the corresponding country's legislation on corresponding chemical substances according to the results of the determination.

### BACKGROUND ART

Thousands of types of chemicals are registered and managed in the country in accordance with the recently tightened chemicals-related laws nationwide or worldwide. Chemicals are registered by their manufacturers and importers, and the country manages and identifies whether chemicals are safely distributed according to the registered contents.

In general, impurities and by-products inevitably remain along with target chemicals in the process of producing the raw materials for chemical products and other products.

Chemicals remaining along with impurities and by-products must be removed through, e.g., refining for each purpose but, in chemical industry in which annual production reaches tons, the time and costs required for removal must be taken into consideration. If residual impurities and by-product chemicals are hazardous chemicals, problems may arise.

Hazardous chemicals are defined as chemicals that are, or are likely to be, hazardous or risky, such as toxic substances, permitted substances, restricted substances, and prohibited substances.

Hazardous chemicals and intensively controlled substances are not allowed to remain even in a trace, or if the maximum residue limit is exceeded, product distribution is prohibited according to the Chemicals Control Act or must be handled through strict management. Accordingly, the value of the product may be lowered, and it is nearly impossible to check all the matters to be considered in industrial handling, previously in the R&D stage.

When a target chemical is developed in lab, the impurities and by-products generated in the chemical reaction are identified mainly by qualitative analysis, and their content is calculated by quantitative analysis.

Further, most petroleum-based chemicals are UVCB substances (Unknown or Variable composition, Complex reaction products or Biological materials). UVCB substances refer to substances whose chemical structure is unknown or variable, complex reaction products, or biological substances. Since it is difficult to determine the constituents of UVCB substances, one whose specific constituents have a specific distribution as a result of complex analysis and identification using several measurement devices is defined as a corresponding chemical.

A criterion for classifying petroleum-based chemicals as hazardous chemicals and intensively controlled substances is the presence or absence of major harmful factors (aromatic carbon compounds, etc.) among the constituents.

Therefore, qualitative and quantitative analysis of hazardous chemical substances and intensively controlled substance products, R&D substances and petroleum-based substances is required.

In relation to the above analysis, an individual analysis method is determined for each chemical. For example, in the case of petroleum-based substances, the CONCAWE consortium involved in the fulfillment of the EU REACH registration of petroleum-based substances presents the composition, process and analysis methods of petroleum-based substances.

Further, producers, importers, and exporters of chemicals and products must interpret the analysis data of the products they handle in accordance with the laws of each country and fulfill their obligations.

However, the task of understanding and applying each country's chemical regulations and identifying obligations requires a lot of time and manpower.

Among other chemicals, high molecular weight compounds are considered to be much less harmful or hazardous than other chemicals because of their general characteristics that they are difficult to penetrate biological membranes due to their particularly large molecular weight.

For this reason, each country's laws and regulations related to chemicals define conditions for high molecular weight compounds and exempt companies from the registration procedure required for conforming chemicals or simplify the registration procedure.

Each country has substantially the same definition for high molecular weight compounds by their national laws and regulations but has a different fulfillment procedure.

Further, it is required to determine whether high molecular weight compounds meet their definitions, interpret the results according to the national laws and perform fulfill the obligations. Thus, a lot of time and manpower are needed to understand each country's chemicals-related laws and regulations and to apply them to identify the obligations.

### DETAILED DESCRIPTION OF THE INVENTION

### Technical Problems

The present invention aims to provide a device and method for reviewing legislation on chemical substances, which determines analysis information to meet each country's legislation on chemical substances and chemical products and automatically provides obligations according to the corresponding country's legislation on corresponding chemical substances according to uses.

The present invention also aims to provide a device and method that performs analysis of chemical substance structure and content, such as GC, HPLC, GC, MS, and LC/MS, on chemical substances or products, to determine analysis information to allow the chemical substance or product to meet each country's legislation, and automatically provides obligations according to legislation on the corresponding chemical substance according to the purpose.

The present invention also aims to perform GPC analysis on high molecular weight compounds among chemical substances, identify the state of registration exemption, the state of residual monomer test, and the state of general chemical substance registration based on, e.g., information about the country to manage high molecular weight compounds according to a user input, GPC measurement data according to the GPC analysis, per-country legislation information according to the country information, and monomer information necessary for legislation interpretation, and to provide guide information or automatically create related documents according to the identified state.

### Means to Address the Problems

According to an embodiment of the present invention, a device for reviewing legislation on a chemical substance comprises an analysis unit performing a qualitative analysis function on a chemical substance or product to grasp a structure of the chemical substance or constituent chemical substances of the chemical product and determining a name of the chemical substance or product; a controller identifying whether the chemical substance or product falls under registration and evaluation, whether the chemical substance or product falls under a cosmetics act, whether the chemical substance or product falls under a pharmaceutical affairs act, or whether the chemical substance or product falls under a narcotic control act in an order according to the acts based on a name, purpose of use, and usage of the chemical substance or product, and legislation information about an applicable country and searching for obligations according to legislation; and a display unit displaying the obligations according to the legislation, searched by the controller.

The analysis unit may further generate GPC measurement data by performing a GPC analysis function on any chemical substance. The controller may determine whether the chemical substance is a high molecular weight compound exempt from registration based on information about a country to manage the high molecular weight compound, the GPC measurement data, per-country legislation information according to the country information, and monomer information required for legislation interpretation and, when the chemical substance is determined to be the high molecular weight compound exempt from registration, automatically create a related document to be submitted to a related organization to be exempt from a registration procedure for the chemical substance determined to be the high molecular weight compound. The display unit may further display the related document.

The device of claim 2, wherein the controller controls the communication unit to transmit the created related document to a server of the related organization when a registration menu displayed on one side of the display unit is selected, and if a process for exemption from a registration procedure for the chemical substance by the transmitted related document is normally performed, receive information indicating that the process for exemption from the registration procedure for the chemical substance determined to be the high molecular weight compound is normally performed from the server of the related organization. The display unit may display the received information indicating that the process for exemption from the registration procedure for the chemical substance determined to be the high molecular weight compound is normally performed.

Further, when the chemical substance is determined to be not the chemical substance exempt from registration, the controller may identify the obligations for the chemical substance based on the information about the country to manage the high molecular weight compound, the GPC measurement data according to the GPC analysis, the per-legislation information according to the country information, and the monomer information required for legislation interpretation. The display unit may display the identified obligations.

Further, the per-country legislation information may include a chemical substance-related law for each country, including the Registration and Evaluation of Chemicals Act of the Republic of Korea and the Toxic Substances Control Act of the United States.

Further, the related document may differ from country to country and include a GPC analysis report and homogeneity data for the Republic of Korea and a certification statement (CS) necessary for record keeping for the United States.

According to another embodiment of the present invention, a method for reviewing legislation on a chemical substance comprises performing, by an analysis unit, a qualitative analysis function on a chemical substance or product to grasp a structure of the chemical substance or constituent chemical substances of the chemical product and determining a name of the chemical substance or product, identifying, by a controller, whether the chemical substance or product falls under registration and evaluation, whether the chemical substance or product falls under a cosmetics act, whether the chemical substance or product falls under a pharmaceutical affairs act, or whether the chemical substance or product falls under a narcotic control act in an order according to the acts based on a name, purpose of use, and usage of the chemical substance or product, and legislation information about an applicable country and searching for obligations according to legislation, and displaying, by a display unit, the obligations according to the legislation, searched by the controller.

Further, the method may further comprise generating, by the analysis unit, GPC measurement data by performing a GPC analysis function on any chemical substance, determining, by the controller, whether the chemical substance is a high molecular weight compound exempt from registration based on information about a country to manage the high molecular weight compound, the GPC measurement data, per-country legislation information according to the country information, and monomer information required for legislation interpretation, when the chemical substance is determined to be the high molecular weight compound exempt from registration, automatically creating, by the controller, a related document to be submitted to a related organization to be exempt from a registration procedure for the chemical substance determined to be the high molecular weight compound, and displaying the related document through the display unit.

Further, the method may further comprise transmitting, by a communication unit, the created related document to a server of the related organization when a registration menu displayed on one side of the display unit is selected, if a process for exemption from a registration procedure for the chemical substance by the transmitted related document is normally performed, receiving, through the communication unit, information indicating that the process for exemption from the registration procedure for the chemical substance determined to be the high molecular weight compound is normally performed from the server of the related organization, and displaying, through the display unit, the information indicating that the process for exemption from the registration procedure for the chemical substance determined to be the high molecular weight compound is normally performed, received through the communication unit.

Further, the method may further comprise, when the chemical substance is determined by the controller to be not the chemical substance exempt from registration, identifying, by the controller, the obligations for the chemical substance based on the information about the country to manage the high molecular weight compound, the GPC measurement data according to the GPC analysis, the per-legislation information according to the country information, and the monomer information required for legislation interpretation; and displaying the identified obligations on the display unit.

### Effects of the Invention

The present invention may determine analysis information to meet each country's legislation on chemical substances and chemical products and automatically provide obligations according to the corresponding country's legislation on corresponding chemical substances according to uses.

Further, it is possible to perform analysis of chemical substance structure and content, such as GC, HPLC, GC, MS, and LC/MS, on chemical substances or products, to determine analysis information to allow the chemical substance or product to meet each country's legislation, and to automatically provide obligations according to legislation on the corresponding chemical substance according to the purpose.

It is also possible to perform GPC analysis on high molecular weight compounds among chemical substances, identify the state of registration exemption, the state of residual monomer test, and the state of general chemical substance registration based on, e.g., information about the country to manage high molecular weight compounds according to a user input, GPC measurement data according to the GPC analysis, per-country legislation information according to the country information, and monomer information necessary for legislation interpretation, and to provide guide information or automatically create related documents according to the identified state.

### BRIEF DESCRIPTION OF THE DRAWINGS

FIG. 1 is a block diagram illustrating a configuration of a device for reviewing legislation on chemical substances according to an embodiment of the present invention.

FIGS. 2 and 3 are flowcharts illustrating a method for reviewing legislation on chemical substances according to an embodiment of the present invention.

FIG. 4 is a flowchart illustrating a method for reviewing legislation on high molecular weight compounds according to an embodiment of the present invention.

FIG. 5 is a view illustrating an example process for reviewing legislation on high molecular weight compound in accordance with the Act on the Registration and Evaluation of Chemical Substances of Korea according to an embodiment of the present invention.

FIG. 6 is a view illustrating an example process for reviewing legislation on high molecular weight compound in accordance with the Toxic Substances Control Act of the United States according to an embodiment of the present invention.

### MODE TO PRACTICE THE INVENTION

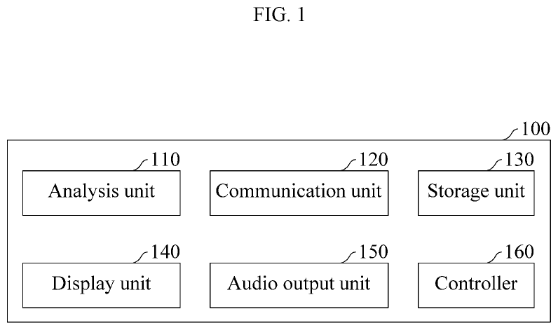

FIG. 1 is a block diagram illustrating a configuration of a device 100 for reviewing legislation on chemical substances according to an embodiment of the present invention.

As shown in FIG. 1, the device 100 for reviewing legislation on chemical substances includes an analysis unit 110, a communication unit 120, a storage unit 130, a display unit 140, an audio output unit 150, and a controller 160. All of the components of the device 100 for reviewing legislation on chemical substances shown in FIG. 1 are not essential components, and the device 100 for reviewing legislation on chemical substances may be implemented with more or less components than those shown in FIG. 1.

According to an embodiment, the device 100 for reviewing legislation on chemical substances may be applicable to various terminals or devices, such as smartphones, portable terminals, mobile terminals, foldable terminals, personal digital assistants (PDAs), portable multimedia players (PMPs), telematics terminals, navigation terminals, personal computers, laptop computers, slate PCs, tablet PCs, ultrabook computers, wearable devices, such as smartwatches, smart glasses, head-mounted displays, etc., Wibro terminals, Internet protocol television (IPTV) terminals, smart TVs, digital broadcast terminals, audio video navigation (AVN) terminals, audio/video (AN) systems, flexible terminals, or digital signage devices.

The analysis unit 110 may perform a qualitative analysis function on any chemical substance or product to grasp the structure of the chemical substance or the constituent chemical substances of the chemical product, and determine the name of the chemical substance or produce based on the grasped results so as to check legislation on the chemical substance or product.

For example, for a paint sample, the analysis 110 may perform a GC/MS analysis function on the sample, identify the constituent chemical substances of the product, and assign a chemical abstract service (CAS) number, e.g., methyl ethyl ketoxime and titanium dioxide, to the product.

The controller 160 may check whether the chemical substance or product falls under registration and evaluation, whether it falls under the Cosmetics Act, whether it falls under the Pharmaceutical Affairs Act, or whether it falls under the Narcotic Control Act in the order according to the laws based on the name and purpose and usage of the chemical substance or product, and the legislation information about the applicable country and search for obligations according to the relevant laws and regulations.

For example, the controller 160 may identify whether the chemical substance/product is subject to registration and evaluation based on the purpose and usage of the chemical substance with a specific CAS number and applicable country legislation information and, if so, the controller 160 may search for obligations according to the relevant legislation. Otherwise, the controller 160 may identify whether it falls under the Cosmetics Act, the Pharmaceutical Affairs Act, the Narcotics Control Act, and other laws in the order according to the laws and, if it is the case, search for obligations according to the corresponding law. For example, the CAS no. 13463-67-7 and no. 96-29-7 substances may be identified as the existing chemical substances KE-33900 and KE-03881, and the CAS no. 96-29-7 substance may be identified as a hazardous chemical substance.

The display unit 140 may output the obligations according to the laws, searched by the controller 160. For example, the display unit 140 may output obligations under the Act on Registration and Evaluation of Chemical Substances corresponding to the manufacture of 100-1000 tons of existing chemical substances and obligations under the Hazardous Chemicals Control Act, etc.

Meanwhile, the analysis 110 performs a GPC (Gel Permeation Chromatography) analysis function on any chemical for the user (or manager) to determine whether the chemical is a high molecular weight compound and generates GPS measurement data (or results of the GPS analysis). In this case, the analysis unit 110 may include a pump (not shown), an injector (not shown), a GPC column (not shown), a detector (not shown), and a data system (not shown) to perform the GPS analysis function. Here, the GPC measurement data includes a retention volume (or retention time), the molecular weight corresponding to the retention volume, an area and a height (differential distribution), a content, and the like.

The communication unit 120 forms a communication connection with any internal component or at least one external terminal via a wired/wireless communication network. In this case, the external terminal may include an externally configured database (not shown), a server (not shown), and the like. Wireless Internet technology which may be adopted for transmission over the wireless communication network may include at least one of wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long-term evolution (LTE), LTE-advanced (LTE-A), LTE V2X (C′V2X), wireless mobile broadband service (VWMBS), or 5G communication. The communication unit 120 may transmit or receive data according to at least one wireless Internet technology which may include not only the above-enumerated techniques but also other non-mentioned Internet techniques. Short-range communication techniques that may be adopted according to an embodiment may include Bluetooth, radio frequency identification (RFID), infrared data association (IrDA), ultra-wideband (UWB), ZigBee, near-field communication (NFC), ultrasound communication (USC), visible light communication (VLC), Wi-Fi, or Wi-Fi direct. Wired communication techniques that may be adopted according to an embodiment may include power line communication (PLC), universal serial bus (USB) communication, Ethernet, serial communication, or optical/coaxial cable communication.

The communication unit 120 may communicate information or data with any terminal via a USB.

The communication unit 120 transmits or receives wireless signals to/from at least one of a base station, the database, or the server over a mobile communication network established as per mobile communication standards, protocols, or schemes, such as global system for mobile communication (GSM), code division multiple access (CDMA), CDMA2000, enhanced voice-data optimized or enhanced voice-data only (EV-DO), wideband CDMA (WCDMA), high speed downlink packet access (HSDPA), high speed uplink packet access (HSUPA), long term evolution (LTE), or LTE-advanced (LTE-A).

Further, the communication unit 120 transmits the GPC measurement data (or GPC analysis result) for the chemical substance to the server or another terminal under the control of the controller 160.

The storage unit 130 stores various user interfaces (UIs) and graphic user interfaces (GUIs).

The storage unit 130 stores a program and data necessary for the device 100 for reviewing legislation on chemical substances to operate.

In other words, the storage unit 130 may store a plurality of application programs or applications driven on the device 100 for reviewing legislation on chemical substances and data and commands for operation of the device 100 for reviewing legislation on chemical substances. At least some of the application programs may be downloaded from an external server via wireless communication. Further, at least some is of these application programs may exist on the device 100 for reviewing legislation on chemical substances from the time of shipment for basic functions of the device 100 for reviewing legislation on chemical substances. Meanwhile, the application program may be stored in the storage unit 130, installed on the device 100 for reviewing legislation on chemical substances, and driven by the controller 160 to perform operations (or functions) of the device 100 for reviewing legislation on chemical substances.

The storage unit 130 may include at least one type of storage medium of flash memory types, hard disk types, multimedia card micro types, card types of memories (e.g., SD or XD memory cards), RAMs (Random Access Memories), SRAMs (Static Random Access Memories), ROMs (Read-Only Memories), EEPROMs (Electrically Erasable Programmable Read-Only Memories), PROMs (Programmable Read-Only Memories), magnetic memories, magnetic disks, or optical discs. The device 100 for reviewing legislation on chemical substances may operate web storage which performs the storage function of the storage unit 130 over the Internet or may operate in association with the web storage.

Further, the storage unit 130 stores the GPC measurement data (or GPC analysis result) for the chemical substance under the control of the controller 160.

The display unit 140 may display various contents, e.g., various menu screens, using the UI and/or GUI stored in the storage unit 130 under the control of the controller 160. The contents displayed on the display unit 140 include a menu screen including various pieces of text or image data (including various information data), icons, a list menu, combo boxes, or other various pieces of data. The display unit 140 may be a touchscreen.

The display unit 140 may include at least one of a liquid crystal display (LCD), a thin film transistor-liquid crystal display (TFT-LCD), an organic light-emitting diode (OLED), a flexible display, or a three-dimensional (3D) display, an e-ink display, or a light emitting diode (LED) display.

Further, the display unit 140 displays, under the control of the controller 160, the GPC measurement data (or GPC analysis results) for the chemical substance and, if the chemical substance is a high molecular weight compound, relevant documents necessary to be exempt from registration under the related laws.

The audio output unit 150 outputs audio information included in a signal signal-processed by the controller 160. The audio output unit 150 may include, e.g., a receiver, a speaker, and a buzzer.

The audio output unit 150 outputs a guidance (or instruction) audio generated by the controller 160.

Further, the audio output unit 150 outputs, under the control of the controller 160, audio information (or sound effect) corresponding to the GPC measurement data (or GPC analysis results) for the chemical substance and, if the chemical substance is a high molecular weight compound, relevant documents necessary to be exempt from registration under the related laws.

The controller (or micro-controller unit (MCU)) 160 executes an overall control function of the device 100 for reviewing legislation on chemical substances.

Further, the controller 160 executes an overall control function of the device 100 for reviewing legislation on chemical substances using programs and data stored in the storage unit 130. The controller 160 may include a RAM, a ROM, a central processing unit (CPU), a graphics processing unit (GPU), and a bus, and the RAM, ROM, CPU, and GPU may be interconnected via the bus. The CPU may access the storage unit 130 and boot the operating system (OS) stored in the storage unit 130. The CPU may perform various operations using various programs, contents, and data stored in the storage unit 130.

Further, the controller 160 determines (or identifies) whether the chemical substance is a high molecular weight compound exempt from registration, based on, e.g., information about the country to manage the high molecular weight compound, the GPC measurement data (or GPC analysis results) according to the GPC analysis, legislation information for each country according to corresponding country information, and monomer information necessary for interpreting legislation. Here, the country information and the monomer information may be previously input and stored in the storage unit 130 by a user input (or the user's/manager's touch/selection/control) or may be input in real-time. The legislation information for each country is chemical substance-related legislation for each country. The legislation information includes the Act on the Registration and Evaluation of Chemicals, the Chemicals Management Act, the Industrial Safety and Health Act, the Dangerous Substances Safety Management Act, and the High Pressure Gas Safety Management Act of the Republic of Korea, and Section 5 of the TSCA (Toxic Substance Control Act, Federal Toxic Substances Control Act) of the U.S. Further, the monomer information includes the CAS no., molecular weight, molecular formula, and structural formula of the monomer, and the like.

As a result of the determination (or the identification), when it is determined that the chemical substance is a high molecular compound exempt from registration, the controller 160 automatically creates related documents that should be submitted to the relevant organization (or government agency) to be exempt from the registration procedure for the chemical substance determined to be the high molecular weight compound. Here, the related documents may differ for each country. In the case of Korea, the related documents include a GPC analysis report and homogeneity data and, in the case of the United States, the related documents include CS (Certification Statement) required for record keeping.

As such, the controller 160 may automatically create related documents to be submitted to be exempt from the registration procedure when the chemical substance is determined to be less hazardous high molecular weight compound.

Further, the controller 160 displays, on the display unit 140, the created related documents that must be submitted to the related organization (or government agency) to be exempt from the registration procedure for the chemical substance determined to be the high molecular weight compound.

Further, when a registration menu (or registration button/item) configured on one side of the display unit 140 is selected, the controller 160 may transmit, to a related organization server (or government agency server) (not shown), through the communication unit 120, the created related documents required to be submitted to the related organization (or government agency) to be exempt from the registration procedure for the chemical substance determined to be a high molecular weight compound, in conjunction with the related organization server (or government agency server).

Further, if the process for being exempt from the registration procedure for the chemical substance by the transmitted related documents is normally performed, the controller 160 may control the communication unit 120 to information indicating that the procedure to be exempt from the registration on the chemical substance determined to be a high molecular weight compound has been normally performed, from the related organization server.

Further, the controller 160 outputs, through the display unit 140 and/or the audio output unit 150, the received information indicating that the procedure to be exempt from the registration on the chemical substance determined to be a high molecular weight compound has been normally performed.

Further, it is determined (or identified) that the chemical substance is not a high molecular weight compound that meets the registration exemption condition, the controller 160 identifies obligations for the chemical substance based on the information about the country to manage the high molecular weight compound, GPC measurement data according to the GPC analysis, per-country legislation information according to the country information, and monomer information necessary for legislation interpretation and displays the identified obligations (or information about the obligations) on the display unit 140. In this case, the obligations may differ depending on the per-country legislation information.

As such, if the chemical substance is not determined to be the high molecular weight compound, the controller 160 may identify the obligations to be performed according to the country's legislation in relation to the chemical substance and output the identified obligations to be identified by the user (or manager).

As such, it is possible to determine analysis information to meet each country's legislation on high molecular weight compounds among chemical substances and automatically provide obligations according to the corresponding country's legislation on corresponding chemical substances according to the results of the determination.

It is also possible to perform GPC analysis on high molecular weight compounds among chemical substances, identify the state of registration exemption, the state of residual monomer test, and the state of general chemical substance registration based on, e.g., information about the country to manage high molecular weight compounds according to a user input, GPC measurement data according to the GPC analysis, per-country legislation information according to the country information, and monomer information necessary for legislation interpretation, and to provide guide information or automatically create related documents according to the identified state.

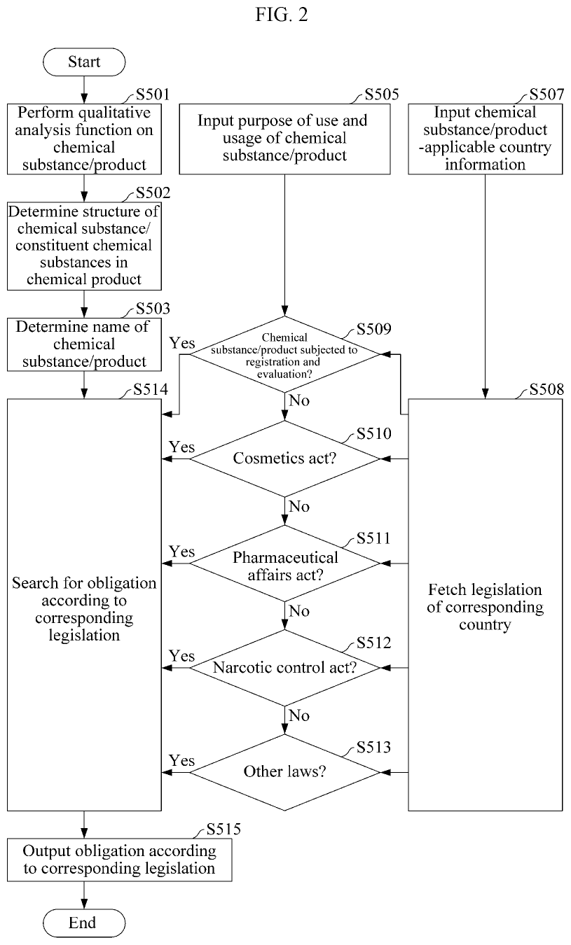

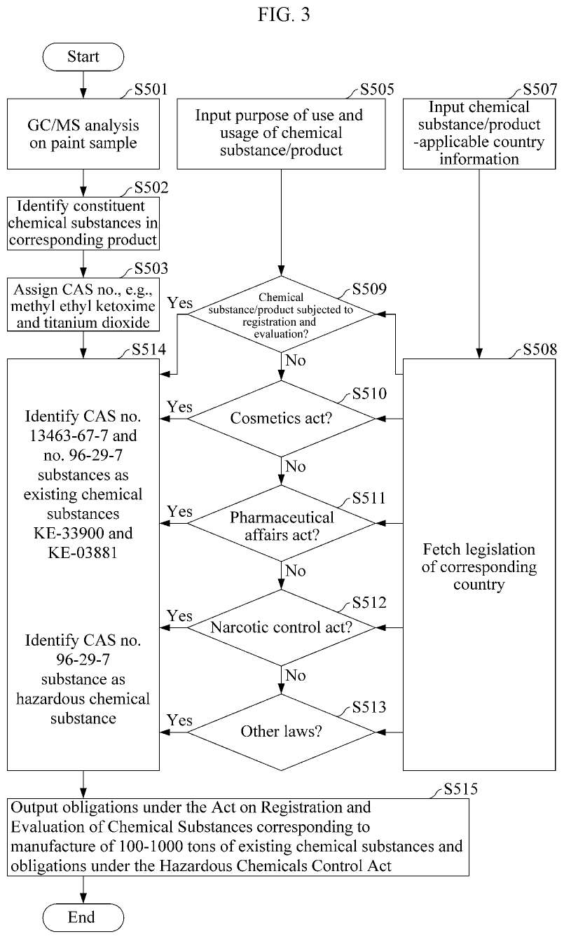

A method for reviewing legislation on high molecular weight compounds according to an embodiment of the present invention is described below in detail with reference to FIGS. 2 and 3.

FIGS. 2 and 3 are flowcharts illustrating a method for reviewing legislation on chemical substances according to an embodiment of the present invention.

First, to check legislation on the chemical substance or product according to an embodiment, as shown in FIG. 2, the analysis unit 110 may perform a qualitative analysis function on any chemical substance or product (S501) to grasp the structure of the chemical substance or the constituent chemical substances of the chemical product (S502), and determine the name of the chemical substance or produce based on the grasped results (S503).

For example, as shown in FIG. 3, for a paint sample, the analysis 110 may perform a GC/MS analysis function on the sample (S501), identify the constituent chemical substances of the product (S502), and assign a chemical abstract service (CAS) number, e.g., methyl ethyl ketoxime and titanium dioxide, to the product (S503).

Thereafter, the controller 160 may receive the name, purpose of use, and usage of the chemical substance or product (S505) and the legislation information of the applicable country (S507) and, based on the received information, identify whether the chemical substance or product falls under registration and evaluation (S509), whether it falls under the Cosmetics Act (S510), whether it falls under the Pharmaceutical Affairs Act (S511), whether it falls under the Narcotic Control Act (S512), and whether it falls under other laws (S513) in the order according to the laws and, if so in each identification process, search for obligations according to the legislation (S514).

For example, as shown in FIG. 3, after receiving the purpose of use and usage of the chemical product with a specific CAS number (S505) and receiving applicable country legislation information (S507), the controller 160 may identify whether the chemical substance/product is subject to registration and evaluation based on the received information and legislation information according to the applicable country information for the chemical substance or product (S509) and, if so, the controller 160 may search for obligations according to the corresponding legislation (S514). Otherwise, the controller 160 may identify whether it falls under the Cosmetics Act, the Pharmaceutical Affairs Act, the Narcotics Control Act, and other laws in the order according to the laws (S510 to S513) and, if it is the case, search for obligations according to the corresponding law. For example, the CAS no. 13463-67-7 and no. 96-29-7 substances may be identified as the existing chemical substances KE-33900 and KE-03881, and the CAS no. 96-29-7 substance may be identified as a hazardous chemical substance (S514).

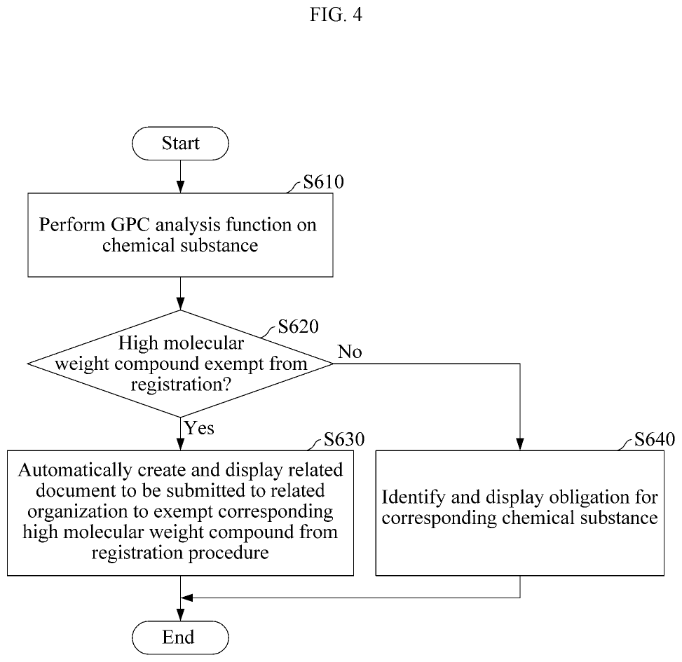

Thereafter, as shown in FIG. 3, the display unit 140 may output the obligations according to the laws, searched by the controller 160 (S515). For example, as shown in FIG. 4, the display unit 140 may output obligations under the Act on Registration and Evaluation of Chemical Substances corresponding to the manufacture of 100-1000 tons of existing chemical substances and obligations under the Hazardous Chemicals Control Act, etc.

FIG. 4 is a flowchart illustrating a method for reviewing legislation on high molecular weight compounds according to an embodiment of the present invention.

The analysis unit 110 performs GPC analysis on a first chemical substance to generate first GPC measurement data.

As another example, the analysis unit 110 performs GPC analysis on a second chemical substance to generate second GPC measurement data (S610).

Thereafter, the controller 160 determines (or identifies) whether the chemical substance is a high molecular weight compound exempt from registration, based on, e.g., information about the country to manage high molecular weight compounds among any chemical substances or products, the GPC measurement data (or GPC analysis results) according to the GPC analysis, legislation information for each country according to corresponding country information, and monomer information necessary for interpreting legislation. Here, the country information and the monomer information may be previously input and stored in the storage unit 130 by a user input (or the user's/manager's touch/selection/control) or may be input in real-time. The legislation information for each country is chemical substance-related legislation for each country. The legislation information includes the Act on the Registration and Evaluation of Chemicals, the Chemicals Management Act, the Industrial Safety and Health Act, the Dangerous Substances Safety Management Act, and the High Pressure Gas Safety Management Act of the Republic of Korea, and TSCA Section 5 of the U.S. Further, the monomer information includes the CAS no., molecular weight, molecular formula, and structural formula of the monomer, and the like.

For example, the controller 160 determines whether the first chemical substance is exempt from registration based on information about a first country (e.g., Korea) to manage the high molecular weight compound, the first GPC measurement data, legislation information according to the first country information, and pre-configured first monomer information necessary for legislation interpretation.

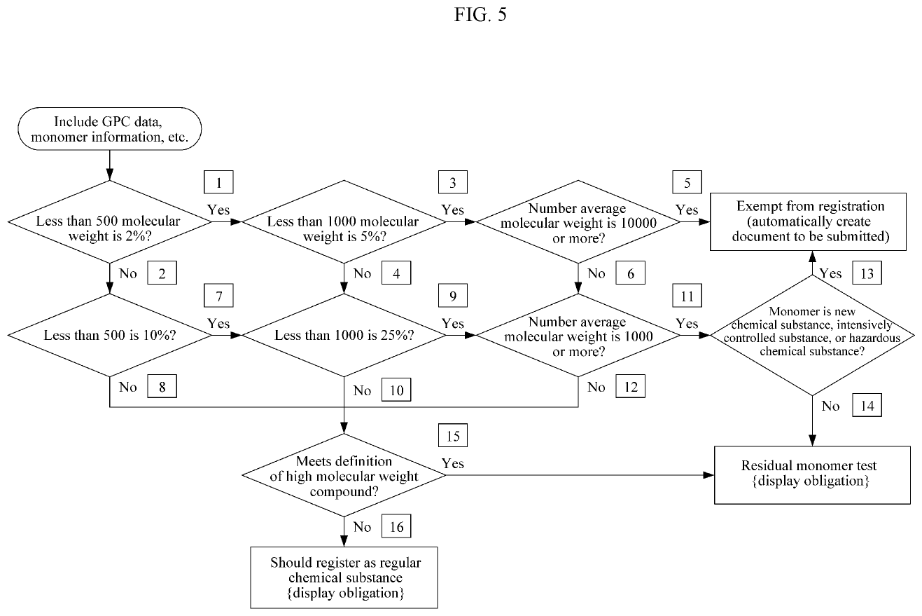

In other words, as shown in FIG. 5, the controller 160 determines whether the is content (or component) less than a molecular weight of 500 in the first GPC measurement data for the first chemical substance is 2% or less, whether the content less than a molecular weight of 500 is 10% or less, whether the content less than a molecular weight of 1000 is 5% or less, whether the content less than a molecular weight of 1000 is 25% or less, whether the number average molecular weight is 10000 or more, whether the number average molecular weight is 1000 or more, whether the monomer is a new chemical substance, intensively controlled substance, or hazardous chemical substance, and it meets the definition of the high molecular weight compound, based on information about a first country (e.g., Korea) to manage the high molecular weight compound, the first GPC measurement data, legislation information according to the first country information, and pre-configured first monomer information necessary for legislation interpretation.

As another example, the controller 160 determines whether the second high molecular weight compound is exempt from registration based on information about a second country (e.g., the United States) to manage the high molecular weight compound, the second GPC measurement data, legislation information according to the second country information, and pre-configured second monomer information necessary for legislation interpretation.

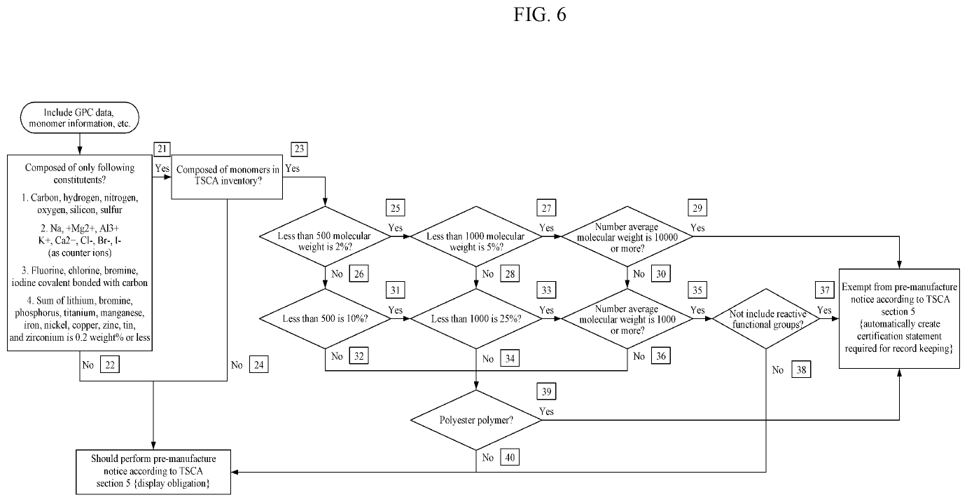

In other words, as shown in FIG. 6, the controller 160 determines whether it is composed of only specific components, whether it is composed of monomers in the TSCA inventory, whether the content less than a molecular weight of 500 is 2% or less, whether the content less than a molecular weight of 500 is 10% or less, whether the content less than a molecular weight of 1000 is 5% or less, whether the content less than a molecular weight of 1000 is 25% or less, whether the number average molecular weight is 10000 or more, whether the number average molecular weight is 1000 or more, whether it contains reactive functional groups, and whether it is a polyester polymer, based on information about a second country (e.g., the United States) to manage the high molecular weight compound, the second GPC measurement data, legislation information according to the second country information, and pre-configured second monomer information necessary for legislation interpretation (S620).

As a result of the determination (or the identification), when it is determined that the chemical substance is a high molecular compound exempt from registration, the controller 160 automatically creates related documents that should be submitted to the relevant organization (or government agency) to be exempt from the registration procedure for the chemical substance determined to be the high molecular weight compound. Here, the related documents may differ for each country. In the case of Korea, the related documents include a GPC analysis report and homogeneity data and, in the case of the United States, the related documents include CS (Certification Statement) required for record keeping.

As such, the controller 160 may automatically create related documents to be submitted to be exempt from the registration procedure when the chemical substance is determined to be a high molecular weight compound.

As an example, as shown in FIG. 5, if it is determined that the content less than a molecular weight of 500 in the first GPC measurement data for the first chemical substance is 2% or more, the content less than a molecular weight of 500 is 10% or more, and it meets the definition of the high molecular weight compound (or in the case of the path 2-8-15), the controller 160 determines that a residual monomer test should be performed and displays information about a residual monomer test on the first chemical substance on the display unit 140 (S630).

As another example, as shown in FIG. 5, if it is determined that the content less than a molecular weight of 500 in the first GPC measurement data for the first chemical substance is 2% or more, the content less than a molecular weight of 500 is 10% or more, and it does not meet the definition of the high molecular weight compound (or in the case of the path 2-8-16), the controller 160 determines that the first chemical substance is registered as a regular chemical substance, automatically creates other related documents to be submitted to a related organization to register the first chemical substance as a regular chemical substance, and displays the created other related documents on the display unit 140. Further, if an additional test is required for the first chemical substance, the controller 160 displays information related to the additional test on the display unit 140.

Further, it is determined (or identified) that the chemical substance is not a high molecular weight compound that meets the registration exemption condition, the controller 160 identifies obligations for the chemical substance based on the information about the country to manage the high molecular weight compound, GPC measurement data according to the GPC analysis, per-country legislation information according to the country information, and monomer information necessary for legislation interpretation and displays the identified obligations (or information about the obligations) on the display unit 140. In this case, the obligations may differ depending on the per-country legislation information.

As such, if the chemical substance is not determined to be a less hazardous high molecular weight compound, the controller 160 may identify the obligations to be performed according to the country's legislation in relation to the chemical substance and output the identified obligations to be identified by the user (or manager).

As an example, as shown in FIG. 5, if it is determined that the content less than a molecular weight of 500 in the first GPC measurement data for the first chemical substance is less than 2%, the content less than a molecular weight of 500 is less than 10%, and it meets the definition of the high molecular weight compound (or in the case of the path 2-8-15), the controller 160 determines that a residual monomer test should be performed and displays information about a residual monomer test on the first chemical substance on the display unit 140.

As another example, as shown in FIG. 5, if it is determined that the content less than a molecular weight of 500 in the first GPC measurement data for the first chemical substance is less than 2%, the content less than a molecular weight of 500 is less than 10%, and it does not meet the definition of the high molecular weight compound (or in the case of the path 2-8-16), the controller 160 determines that the first chemical substance is registered as a regular chemical substance, automatically creates other related documents to be submitted to a related organization to register the first chemical substance as a regular chemical substance, and displays the created other related documents on the display unit 140. Further, if an additional test is required for the first chemical substance, the controller 160 displays information related to the additional test on the display unit 140.

As another example, as shown in FIG. 6, if it is determined that the second chemical substance is not composed of only specific components (or in the case of the path 22), the controller 160 displays an obligation indicating that pre-manufacture notices need to be done according to TSCA Section 5 on the display unit 140 (S640).

According to embodiments of the present invention, as described above, any chemical substance or product and analysis information to allow high molecular weight compounds among chemical substances to meet legislation of each country are determined and, according to a result of the determination, obligations according to the legislation on the corresponding chemical substance of the corresponding country are is automatically provided according to the purpose. Thus, it is possible to save time and efforts to check legislation related to chemical substances and fulfill obligations.

Further, according to embodiments of the present invention, as described above, it is also possible to perform GPC analysis on chemical substances or products, and high molecular weight compounds among chemical substances, identify the state of registration exemption, the state of residual monomer test, and the state of general chemical substance registration based on, e.g., information about the country to manage high molecular weight compounds according to a user input, GPC measurement data according to the GPC analysis, per-country legislation information according to the country information, and monomer information necessary for legislation interpretation, and to provide guide information or automatically create related documents according to the identified state. Thus, it is possible to enhance overall operation efficiency.

1. A device for reviewing legislation on a chemical substance, comprising:
an analysis unit performing a qualitative and quantitative analysis function on a chemical substance or product to grasp a structure and concentration of the chemical substance or constituent chemical substances of the chemical product and determining a name and content of the chemical substance or product;
a controller identifying whether the chemical substance or product falls under registration and evaluation, whether the chemical substance or product falls under a cosmetics act, whether the chemical substance or product falls under a pharmaceutical affairs act, or whether the chemical substance or product falls under a narcotic control act in an order according to the acts based on a name, purpose of use, and usage of the chemical substance or product, and legislation information about an applicable country and searching for obligations according to legislation; and
a display unit displaying the obligations according to the legislation, searched by the controller.

2. The device of claim 1, wherein the analysis unit further generates GPC measurement data by performing a GPC analysis function on any chemical substance, wherein the controller determines whether the chemical substance is a high molecular weight compound exempt from registration based on information about a country to manage the high molecular weight compound, the GPC measurement data, per-country legislation information according to the country information, and monomer information required for legislation interpretation and, when the chemical substance is determined to be the high molecular weight compound exempt from registration, automatically creates a related document to be submitted to a related organization to be exempt from a registration procedure for the chemical substance determined to be the high molecular weight compound, and wherein the display unit further displays the related document.

3. The device of claim 2, wherein the controller controls the communication unit to transmit the created related document to a server of the related organization when a registration menu displayed on one side of the display unit is selected, and if a process for exemption from a registration procedure for the chemical substance by the transmitted related document is normally performed, receive information indicating that the process for exemption from the registration procedure for the chemical substance determined to be the high molecular weight compound is normally performed from the server of the related organization, and wherein the display unit displays the received information indicating that the process for exemption from the registration procedure for the chemical substance determined to be the high molecular weight compound is normally performed.

4. The device of claim 2, wherein when the chemical substance is determined to be not the chemical substance exempt from registration, the controller identifies the obligations for the chemical substance based on the information about the country to manage the high molecular weight compound, the GPC measurement data according to the GPC analysis, the per-legislation information according to the country information, and the monomer information required for legislation interpretation, and wherein the display unit displays the identified obligations.

5. The device of claim 2, wherein the per-country legislation information includes a chemical substance-related law for each country, including the Registration and Evaluation of Chemicals Act of the Republic of Korea and the Toxic Substances Control Act of the United States.

6. The device of claim 2, wherein the related document differs from country to country and includes a GPC analysis report and homogeneity data for the Republic of Korea and a certification statement (CS) necessary for record keeping for the United States.

7. A method for reviewing legislation on a chemical substance, the method comprising:
performing, by an analysis unit, a qualitative and quantitative analysis function on a chemical substance or product to grasp a structure and concentration of the chemical substance or constituent chemical substances of the chemical product and determining a name and content of the chemical substance or product;
identifying, by a controller, whether the chemical substance or product falls under registration and evaluation, whether the chemical substance or product falls under a cosmetics act, whether the chemical substance or product falls under a pharmaceutical affairs act, or whether the chemical substance or product falls under a narcotic control act in an order according to the acts based on a name, purpose of use, and usage of the chemical substance or product, and legislation information about an applicable country and searching for obligations according to legislation; and
displaying, by a display unit, the obligations according to the legislation, searched by the controller.

8. The method of claim 7, further comprising: generating, by the analysis unit, GPC measurement data by performing a GPC analysis function on any chemical substance; determining, by the controller, whether the chemical substance is a high molecular weight compound exempt from registration based on information about a country to manage the high molecular weight compound, the GPC measurement data, per-country legislation information according to the country information, and monomer information required for legislation interpretation; when the chemical substance is determined to be the high molecular weight compound exempt from registration, automatically creating, by the controller, a related document to be submitted to a related organization to be exempt from a registration procedure for the chemical substance determined to be the high molecular weight compound; and displaying the related document through the display unit.

9. The method of claim 8, further comprising:
transmitting, by a communication unit, the created related document to a server of the related organization when a registration menu displayed on one side of the display unit is selected;
if a process for exemption from a registration procedure for the chemical substance by the transmitted related document is normally performed, receiving, through the communication unit, information indicating that the process for exemption from the registration procedure for the chemical substance determined to be the high molecular weight compound is normally performed from the server of the related organization; and
displaying, through the display unit, the information indicating that the process for exemption from the registration procedure for the chemical substance determined to be the high molecular weight compound is normally performed, received through the communication unit.

10. The method of claim 8, further comprising:
when the chemical substance is determined by the controller to be not the chemical substance exempt from registration, identifying, by the controller, the obligations for the chemical substance based on the information about the country to manage the high molecular weight compound, the GPC measurement data according to the GPC analysis, the per-legislation information according to the country information, and the monomer information required for legislation interpretation; and
displaying the identified obligations on the display unit.
